(19) United States
(12) Patent Application Publication
(10) Pub. No.: US 2012/0062429 A1
(43) Pub. Date: Mar. 15, 2012

(54) PORTABLE RADIO

(75) Inventors: Hiroyuki Uno, Ishikawa (JP); Yoshio Koyanagi, Kanagawa (JP); Tomoaki Nishikido, Ishikawa (JP)

(73) Assignee: PANASONIC CORPORATION, Osaka (JP)

(21) Appl. No.: 13/321,952

(22) PCT Filed: Feb. 22, 2010
(86) PCT No.: PCT/JP2010/001158

§ 371 Date: Nov. 22, 2011

(30) Foreign Application Priority Data
May 27, 2009 (JP) 2009-127360

(51) Int. Cl. H01Q 1/24

(52) U.S. Cl. 343/702

(57) ABSTRACT

There is provided a foldable portable radio capable of yielding high emission efficiency over a wide band in either a closed or open state.

A portable radio 100 is comprised of: a lower housing 101 making up a first housing; an upper housing 102 making up a second housing; a hinge 103 for coupling the lower housing 101 to the upper housing 102 in a turnable manner; a first circuit board 104; a second circuit board 105; an antenna element 106; a radio circuit 107; an impedance matching circuit 108; a signal line 109 that connects the first circuit board 104 to the second circuit board 105; and a conductor element 110. The conductor element 110 has a length that is a quarter wavelength of an operating frequency and is placed in the hinge 103 of the upper housing 102. The conductor element 110 is electrically connected to a ground of the second circuit board 105 placed on the upper housing 102, and the electrical connection is set at any position between a center of the housing along its widthwise direction and an end of the housing located opposite a feed point 111 of the antenna element 106.

### TECHNICAL FIELD

The present invention relates to a foldable portable radio exhibiting a wideband, high efficiency antenna performance in either a closed or open state.

### BACKGROUND ART

Numerous types of cell phones have recently been developed. Folding type cell phones in which an upper housing and a lower housing are opened and closed around a hinge have widely prevailed. From the viewpoint of ease of carry and a design characteristic, recent cell phones are required to be compact and slim. Concurrently, the cell phone is used not only at home but in various areas, like outside the country. For this reason, the cell phone is required to operate in many frequency bands (e.g., 800 MHz band, 1.5 GHz band, 1.7 GHz band, and 2 GHz band in the country; a 900 MHz band, a 1.8 GHz band, and a 1.9 GHz band outside the country). Therefore, the antenna meets a big challenge when assuring a wideband characteristic in either an open or closed state as well as when being materialized in a smaller built-in antenna.

An antenna element provided in a folding cell phone is usually incorporated in a hinge in many cases so as to be protected from a problem, like influence of a hand during conversation. In relation to such a built-in antenna, there is; for instance, a known technique for adding a resonant element to a metallic hinge conductor and activating the resonant element as an antenna, to thus implement multi-band operation.

For instance, an antenna system, like that described in connection with Patent Document 1, has already been proposed as a technique for assuring high antenna performance over a wide band even when the system is opened or closed. When opened, the antenna system makes a conductor plate placed in an upper housing and a circuit board placed in a lower housing work as a dipole antenna. When closed, the antenna system makes a monopole antenna placed at a bottom of the lower housing work. At this time, in the closed state, a portion of the conductor plate in the upper housing overlapping the monopole antenna element is separated, to thus make the antenna system operate over wideband in the closed state. It is thereby possible to achieve antenna performance over a wide band even in either a closed or open state.

By the way, when an attempt is made to cover the plurality of frequency bands by means of one or a small number of antenna elements with a view toward miniaturizing a cell phone, there sometimes arise a phenomenon of antenna performance being deteriorated at a specific frequency. A technique using a short-circuit conductor, such as that described in connection with; for instance, Patent Document 2 and Patent Document 3, has hitherto been proposed as a technique for lessening deterioration.

An antenna described in connection with Patent Document 2 is for diminishing an SAR (Specific Absorption Rate) of only a specific frequency to a limited value or less. A short-circuit conductor is placed in a vicinity of an area where a flexible cable for connecting an upper circuit board to a lower circuit board is connected to the lower circuit board, whereby an SAR of a 2 GHz band can be diminished.

In an antenna described in connection with Patent Document 3, an upper circuit board and a lower circuit board are connected in a vicinity of a power feed block placed in a hinge in order to accomplish high antenna performance on the desk, and a short-circuit conductor is placed in a vicinity of a position of connection of the upper circuit board in the upper housing.

### RELATED ART DOCUMENT

### Patent Document

Patent Document 1: JP-A-2006-014128
Patent Document 2: WO2007/004499
Patent Document 3: WO2006/112160

### SUMMARY OF THE INVENTION

### Problem that the Invention is to Solve

However, as shown in FIG. 7, in a multi-band antenna using a hinge conductor built in a hinge encounters a problem that, electric currents of opposite phases flow through upper and lower circuit boards at a frequency band in which an entire housing of a folding cell phone assumes a length of about one wavelength (each of upper and lower housings assumes a length of about one-half wavelength). For this reason, the antenna encounters a problem of high emission efficiency being not achieved in a closed state. For instance, in a common folding cell phone, each of upper and lower housings assumes a length of about 100 mm. Hence, it can be said to be difficult to cope with a 1.5 GHz band.

The antenna system described in connection with Patent Document 1 requires control for switching an antenna element by means of opening and closing operation. For this reason, the antenna system encounters a problem of a configuration of the system becoming complicate. As mentioned previously, even the antennas described in connection with Patent Documents 2 and 3 also encounter a problem of high antenna performance being not accomplished in a closed state at a frequency band in which the entire housing assumes a length of about one wavelength (each of upper and lower housings assumes a length of about one-half wavelength).

The present invention has been conceived under the circumstance and aims at attaining high antenna performance in a specific frequency band at which an entire housing of a cell phone assumes a length of about one wavelength in either a closed or open state without switching the antenna. High antenna performance can thereby be accomplished over a wide band in either an open or closed state.

### Means for Solving the Problem

A portable radio of the present invention adopts a configuration comprising: a first housing; a first circuit board provided in the first housing and having, in its longitudinal direction, a length which is about one-half of a wavelength of an operating frequency; a second housing; a second circuit board provided in the second housing and that having, in its longitudinal direction, a length which is about one-half of a wavelength of the operating frequency; a hinge coupling the first housing to the second housing in a turnable manner; a radio circuit placed on the first circuit board; an antenna element placed at a point on the first housing that is close to the hinge and that is connected to the radio circuit; and a conductor element that is placed at a point on the second housing that is close to the hinge and that has an electric length equal to about a quarter wavelength of the operating frequency, wherein one end of the conductor element is short-circuited to a point on the second circuit board opposite to a feed position of the antenna element with reference to a center of the second circuit board located in proximity to the hinge. The configuration makes it possible to achieve, even at a frequency band where a length of an entire housing comes to one wavelength, high emission efficiency even in a folded state while sustaining high emission efficiency in an open state.

Moreover, the portable radio of the present invention adopts a configuration in which the antenna element is a conductor hinge member placed in the hinge. In the configuration, an existing component is used as an antenna element, and hence an antenna component is not required, and cost can be curtailed.

The portable radio of the present invention adopts a configuration in which the conductor element assumes a meandering shape. The configuration enables miniaturization of the conductor element.

The portable radio of the present invention also adopts a configuration in which the conductor element is electrically connected to the second circuit board by way of a reactance element. The configuration enables miniaturization of the conductor element and easy adjustment of a resonance frequency.

The portable radio of the present invention also adopts a configuration in which the conductor element is electrically connected to the second circuit board by way of a band block circuit. The configuration make it possible to block a frequency band at which the antenna element and the conductor element are coupled. Hence, deterioration of antenna performance, which would otherwise be caused by coupling, can be diminished.

### Advantage of the Invention

Even when each of lower and upper housings assumes a one-half wavelength along its lengthwise direction and the entire housing assumes one wavelength at an operating frequency, the portable radio of the present invention can exhibit high emission efficiency even in an open or closed state. High antenna performance can thereby be accomplished over a wide band.

### BRIEF DESCRIPTION OF THE DRAWINGS

FIGS. 1 (A) and (B) are views showing an open state of a portable radio of a first embodiment of the present invention.

FIG. 2 is a view showing a closed state of the portable radio of the first embodiment of the present invention.

FIGS. 3 (A) and (B) are views showing another configuration of the portable radio of the first embodiment of the present invention.

FIG. 4 is a view showing another configuration of the portable radio of the first embodiment of the present invention.

FIG. 5 is a view showing an open state of a portable radio of a second embodiment of the present invention.

FIG. 6 is a view showing another configuration of the portable radio of the second embodiment of the present invention.

FIG. 7 is a view showing a closed state of a portable radio having a related art configuration.

### EMBODIMENTS FOR IMPLEMENTING THE INVENTION

Preferred embodiments of the present invention are hereunder described in detail by reference to the drawings.

### First Embodiment

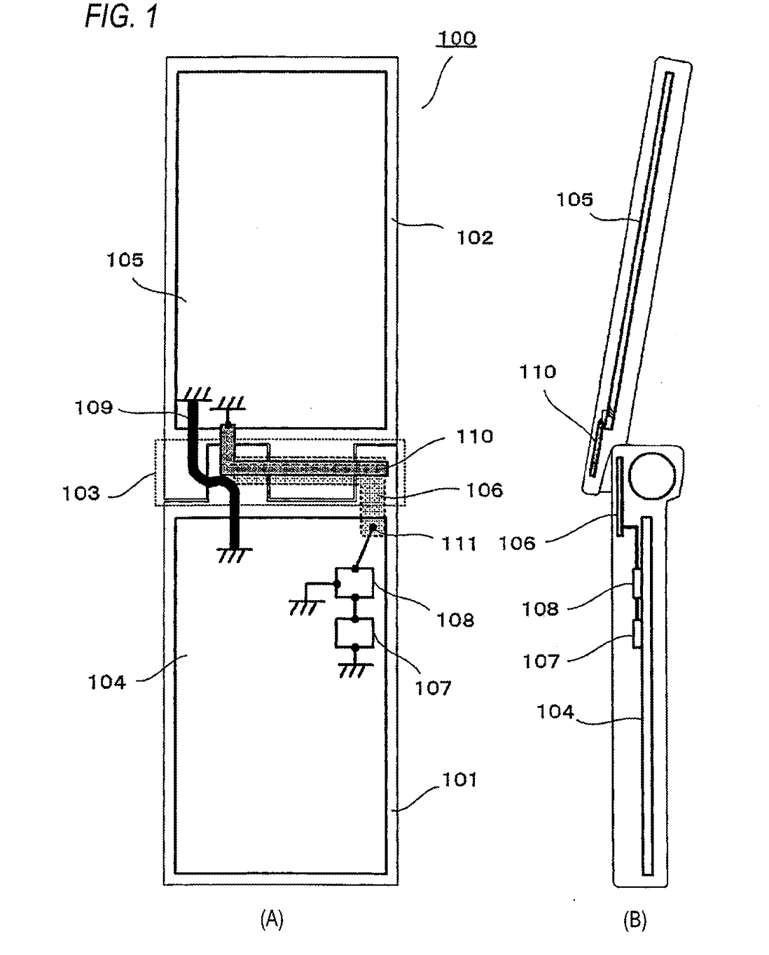

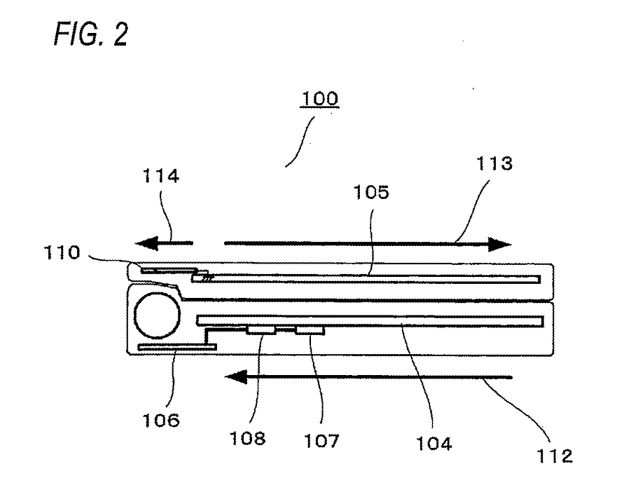

FIGS. 1(A) and (B) show an open state of a portable radio 100 of a first embodiment of the present invention, wherein FIG. 1(A) is a front view and wherein FIG. 1(B) is a side view. FIG. 2 shows a closed, folded state of the portable radio 100 of the first embodiment of the present invention.

The portable radio 100 includes a lower housing 101 making up a first housing, an upper housing 102 making up a second housing, a hinge 103 that couples, in a turnable manner, the lower housing 101 to the upper housing 102, a first circuit board 104, a second circuit board 105, an antenna element 106, a radio circuit 107; an impedance matching circuit 108, a signal line 109 that connects the first circuit board 104 to the second circuit board 105, and a conductor element 110. A configuration of each of the elements is now described in detail.

The lower housing 101 includes an operation block other than an illustrated operation block, the first circuit board 104, the antenna element 106, the radio circuit 107, and the impedance matching circuit 108. The upper housing 102 includes a display block other than an illustrated display block, the second circuit board 105, and the conductor element 110.

The lower housing 101 and the upper housing 102 are coupled by means of the hinge 103 and operate in a turnable manner. The hinge 103 designates a location where a rotary shaft is placed. In the present invention, the hinge designates an area of the lower housing 101 and an area of the upper housing 102 surrounded by a dotted line shown in FIG. 1(A). At this time, as shown in FIG. 1(B), the rotary shaft is placed in the hinge 103 on the lower housing 101. A ground is placed over a substantially entire surface of the first circuit board 104 and a substantially entire surface of the second circuit board 105. The antenna element 106 is placed at an end of the lower housing 101 close to the hinge 103 and is excited by way of a feed point 111 on an end of the first circuit board 104. The antenna element 106 is set to a quarter wavelength of an operating frequency at this time and operates as a monopole antenna.

The radio circuit 107 is placed on the first circuit board 104 in the lower housing 101 and electrically connected to the ground of the first circuit board 104. The radio circuit 107 is electrically connected to the impedance matching circuit 108. The impedance matching circuit 108 is inserted between the antenna element 106 and the radio circuit 107 and matches impedance of the antenna element 106 with impedance of the radio circuit 107.

The signal line 109 is made up of a flexible cable including; for instance, a plurality of signal lines and ground lines. The signal line 109 electrically connects a circuit component other than an illustrated circuit component to be populated on the first circuit board 104, such as that typified by a control circuit, to a circuit component other than an illustrated circuit component to be populated on the second circuit board 105, such as that typified by a liquid crystal display block, by way of the hinge 103. In order to increase emission efficiency of the antenna element 106, the signal line 109 is connected to the first circuit board 104 while separated from the feed point 111 of the antenna element 106 by predetermined space. In relation to a location where the feed point 111 and the signal line 109 are connected to the first circuit board 104, it is preferable that the feed point 111 and the signal line 109 be positioned at respective ends on the first circuit board 104 along its widthwise direction. From the viewpoint of routing of a cable and prevention of a broken wire, the signal line 109 is connected to a side of the second circuit board 105 at which it is connected to the first circuit board 104.

The conductor element 110 is placed at an end of the upper housing 102 close to the hinge 103. The conductor element 110 is electrically connected to the ground of the second circuit board 105. Specifically, the conductor element 110 is connected to a position that is opposing to the feed point 111 of the antenna element 106 with respect to the widthwise direction of the housing; for instance, any position between the center of the width of the housing and an end of the upper housing opposing the feed point.

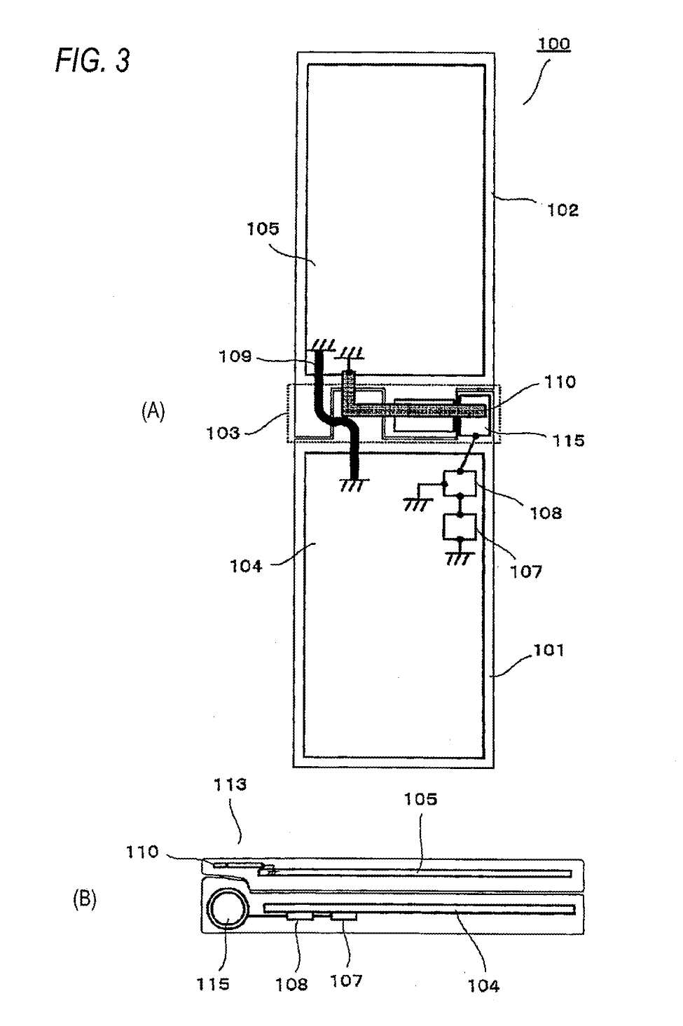

Operation of the antenna of the portable radio configured as mentioned above is described in detail by reference to FIGS. 2, 3(A) and 3(B). An operating frequency is hereunder taken as 1.5 GHz band.

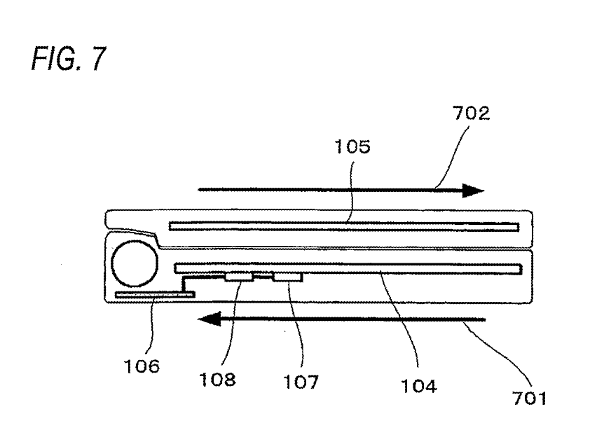

First, an explanation is given to operation performed when the lower housing 101 and the upper housing 102 are folded; namely, in a closed state. In relation to a cell phone typified by the portable radio; in particular, a folding cell phone, a longitudinal length of each of upper and lower housings is generally set to a value of about 100 mm, from a viewpoint of ease of carry, or the like, and the length comes to about one-half wavelength at 1.5 GHz. When the antenna element 106 is thereby activated as a monopole antenna in the closed state, an electric current 701 becomes distributed over a ground pattern of the first circuit board 104 in the related art portable radio as shown in FIG. 7. Further, an electric current 702 becomes distributed over a ground pattern of the second circuit 105 by way of the signal line 109. Arrows assigned to the respective electric currents 701 and 702 designate respective phases of the electric currents. As mentioned above, when the length of the housing achieved along its longitudinal direction is one-half the wavelength of the operation frequency, the electric current 701 distributed over the first circuit board 104 of the lower housing 101 and the electric current 702 distributed over the second circuit board 105 of the upper housing 102 have opposite phases, to thus come to cancel each other, so that a reduction in emission resistance takes place, thereby significantly deteriorating emission efficiency.

Accordingly, as shown in FIG. 2, the conductor element 110 that assumes a length of about 50 mm (a quarter wavelength) when electrically connected to the ground of the second circuit board 105 is placed in the hinge 103 of the upper housing 102, whereby an electric current 114 becomes distributed over the conductor element 110. An electric current 112 distributed over the first circuit board 104 of the lower housing 101 and the electric current 113 distributed over the second circuit board 105 of the upper housing 102 have opposite phases, to thus cancel each other. Meanwhile, the electric currents 112 and 114 intensify each other, so that emission resistance is increased. Emission efficiency is therefore improved. At this time, it is desirable that the conductor element 110 be connected, in a vicinity of a location where the signal line 109 is connected to the second circuit board 105, to a point on the second circuit board 105 opposite to the feed point 111 with reference to the center of the widthwise direction of the housing of the second circuit board 105. The electric current thereby becomes easier to spread over the conductor element 110, so that an effect for enhancing emission efficiency is enhanced.

Operation performed when the lower housing 101 and the upper housing 102 are opened is now described. In an open state, the electric current 112 flowing through the ground pattern of the first circuit board 104 and the electric current 113 flowing through the ground pattern of the second circuit board 105 are oriented in the same direction, so that the antenna element acts as a single-wavelength dipole antenna. Specifically, the entire housing of the portable radio can be operated as an antenna in an open state, so that high emission efficiency can be acquired. An electric current of opposite phase develops as a result of addition of the conductor element 110. Although slight deterioration of efficiency is found, an amount of deterioration is small, and emission efficiency is originally high. For these reasons, influence on antenna performance is small. A position of the connection between the signal line 109 and the first circuit board 104 and a position of the connection between the signal line 109 and the second circuit board 105 are set at positions located opposite the feed point 111 along the widthwise direction of the housing. Emission resistance can thereby be enhanced, and emission efficiency can be increased further.

According to the first embodiment, in the foldable portable radio, the conductor element is placed in the hinge of the upper housing as mentioned above and electrically connected to a point on the ground of the second circuit board that is opposite to the feed point of the antenna element in the widthwise direction of the housing. As a result, even when each of the lower and upper housings assumes, along its longitudinal direction, a one-half wavelength at an operating frequency, high emission efficiency can be achieved even in a folded state while high emission efficiency is maintained in an open state.

In the embodiment, a monopole antenna element is placed in the hinge of the lower housing. As shown in FIGS. 3(A) and 3(B), even when a hinge conductor 115 required to realize a hinge structure is used as an antenna element, a similar advantage can be yielded.

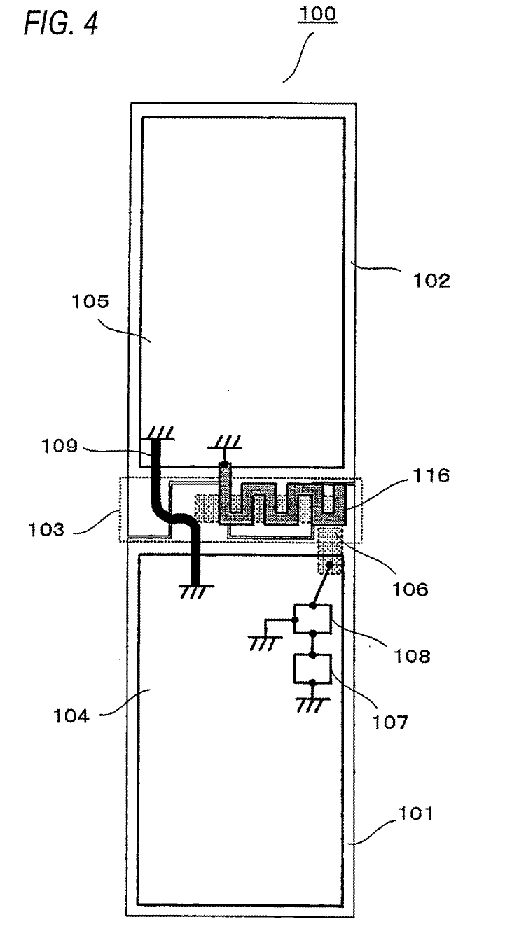

In the embodiment, although the conductor element is described as having a linear shape, an equivalent advantage can also be yielded even when the conductor element is embodied as a meandering antenna element 116 as shown in FIG. 4.

### Second Embodiment

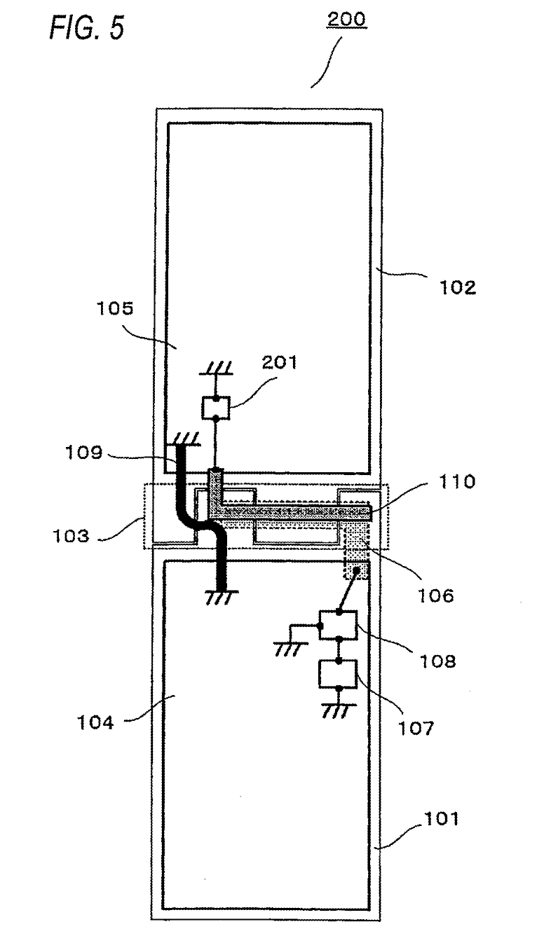

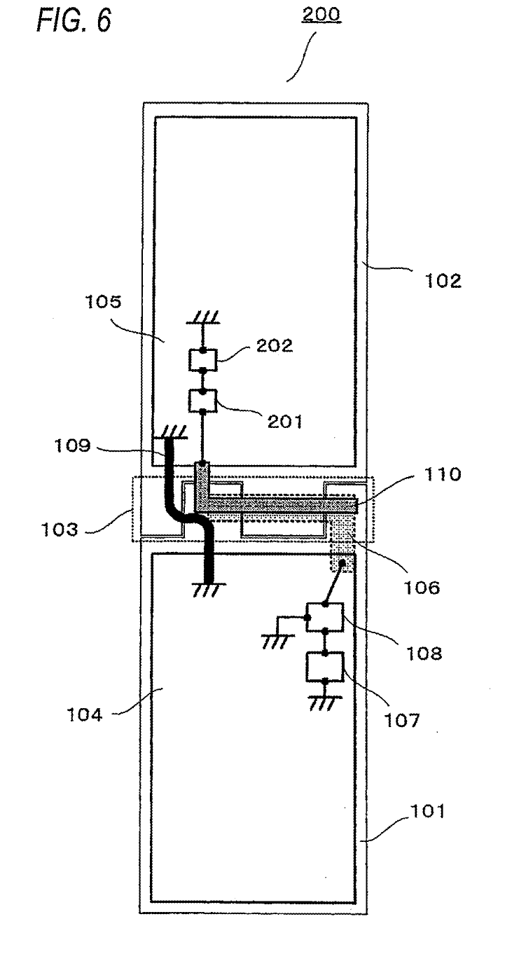

A second embodiment of the present invention is now described in detail by reference to FIGS. 5 and 6. FIG. 5 shows an open state of a portable radio 200 of the second embodiment of the present invention. In FIG. 5, elements that are identical with their counterparts described in connection with the first embodiment are assigned the same reference numerals, and their repeated, detailed explanations are omitted here for brevity.

The portable radio 200 is equivalent to the portable radio 100 described in connection with the first embodiment, in which the conductor element 110 is electrically connected to the second circuit board 105 through a reactance element 201.

The reactance element 201 is; for instance, an inductance, and is interposed between the conductor element 110 and the ground of the second circuit board 105. Since the length of the conductor element 110 can thereby be shortened, the conductor element can be miniaturized. Further, a resonance frequency of the conductor element 110 can be easily adjusted.

FIG. 6 shows that a band block circuit 202 is inserted between the reactance element 201 and the second circuit board 105 in connection with the configuration shown in FIG. 5.

The band block circuit 202 is made up of; for instance, a notched filter including a parallely-connected LC. It is thereby becomes possible to block a frequency band at which the conductor element 110 and the antenna element 106 placed in the hinge 103 are electromagnetically coupled, so that deterioration of antenna performance, which would otherwise be caused by coupling, can be diminished.

As mentioned above, in the second embodiment, the conductor element is connected to the ground of the second circuit board through the reactance element, thereby enabling miniaturization of the conductor element and easy adjustment of a resonance frequency. The band block circuit is inserted between the conductor element and the second circuit board, thereby enabling blocking of a frequency band at which the antenna element and the conductor element are coupled and lessening of deterioration of antenna performance, which would otherwise be caused by coupling.

In the embodiment, the conductor element, the reactance element, and the band block circuit are connected, in this sequence, to the ground of the second circuit board. However, the same advantage can also be yielded even when the conductor element, the band block circuit, and the reactance element are connected, in this sequence, to the ground of the second circuit board.

The band block circuit has been described as one in the present embodiment. However, when there is a necessity to block a plurality of bands, a plurality of band block circuits can also be connected correspondingly.

Although the present invention has been described in detail and by reference to the specific embodiments, it is manifest to those skilled in the art that the present invention is susceptible to various alterations or modifications without departing the spirit and scope of the present invention.

The present patent application is based on Japanese Patent Application (JP-2009-127360) filed on May 27, 2009, the entire subject matter of which is incorporated herein by reference.

### INDUSTRIAL APPLICABILITY

A portable radio of the present invention yields an advantage of high emission efficiency being achieved over a wide band even in either a closed or open state and is useful for a portable radio; for instance, a folding cell phone.

### DESCRIPTIONS OF THE REFERENCE NUMERALS AND SYMBOLS

100 PORTABLE RADIO
101 LOWER HOUSING
102 UPPER HOUSING
103 HINGE
104 FIRST CIRCUIT BOARD
105 SECOND CIRCUIT BOARD
106 ANTENNA ELEMENT
107 RADIO CIRCUIT
108 IMPEDANCE MATCHING CIRCUIT
109 SIGNAL LINE
110 CONDUCTOR ELEMENT
111 FEED POINT

1. A portable radio comprising:
a first housing;
a first circuit board provided in the first housing and having in its longitudinal direction, a length which is about one-half of a wavelength of an operating frequency;
a second housing;
a second circuit board provided in the second housing and having, in its longitudinal direction, a length which is about one-half of a wavelength of the operating frequency;
a hinge coupling the first housing to the second housing in a turnable manner;
a radio circuit placed on the first circuit board;
an antenna element placed at a point on the first housing that is close to the hinge and connected to the radio circuit; and
a conductor element placed at a point on the second housing that is close to the hinge and having an electric length equal to about a quarter wavelength of the operating frequency,
wherein one end of the conductor element is short-circuited to a point on the second circuit board that is opposite to a feed position of the antenna element with reference to a center of the second circuit board located in proximity to the hinge.

2. The portable radio according to claim 1, wherein the antenna element includes a conductor hinge member placed in the hinge.

3. The portable radio according to claim 1, wherein the conductor element includes a meandering shape.

4. The portable radio according to claim 1, wherein the conductor element is electrically connected to the second circuit board through a reactance element.

5. The portable radio according to claim 1, wherein the conductor element is electrically connected to the second circuit board through a band block circuit.
